(19) United States
(12) Patent Application Publication
(10) Pub. No.: US 2007/0209758 A1
(43) Pub. Date: Sep. 13, 2007

(54) METHOD AND PROCESS FOR UNITIZED MEA

(76) Inventors: Bhaskar Sompalli, Rochester, NY (US); Michael K. Budinski, Pittsford, NY (US); Brian A. Litteer, Henrietta, NY (US); Lindsey A. Karpovich, Hilton, NY (US)

Correspondence Address: Charles Ellerbrock;General Motors Corporation, Legal Staff - Mail Code 482-C23-B21, 300 Renaissance Center, PO Box 300, Detroit, MI, 48265-3000, US

(21) Appl. No.: 11/750,224

(22) Filed: May 17, 2007

Related U.S. Application Data
(62) Division of application No. 11/010,770, filed on Dec. 13, 2004.

(51) Int. Cl. C09J 4/00; B32B 37/00; B44D 5/00

(52) U.S. Cl. 156/330.9; 156/60; 156/82

(57) ABSTRACT

A method of forming a fuel cell may include treating a surface of a membrane electrode assembly (MEA) of the fuel cell, positioning a preformed adhesive insert on the treated surface, and bonding an electrically conductive member to the treated surface with the adhesive. Treating the surface may include a pre-treatment to increase adhesive properties thereof. Positioning the adhesive insert may include locating the adhesive insert on a surface of the membrane electrolyte adjacent to an edge of the electrode.

### CROSS-REFERENCE TO RELATED APPLICATIONS

This application is a divisional application and claims the benefit of U.S. patent application Ser. No. 11/010,770, filed on Dec. 13, 2004. The disclosure of the above application is incorporated herein by reference.

### FIELD

The present disclosure relates to a membrane electrode assembly for a fuel cell, and to a method and process for preparing a membrane electrode assembly.

### BACKGROUND

Fuel cells are being developed as a power source for electric vehicles and other applications. One such fuel cell is the PEM (i.e. Proton Exchange Membrane) fuel cell that includes a so-called “membrane-electrode-assembly” (MEA) comprising a thin, solid polymer membrane-electrolyte having a pair of electrodes (i.e., an anode and a cathode) on opposite faces of the membrane-electrolyte. The MEA is sandwiched between planar gas distribution elements.

In these PEM fuel cells, the electrodes are typically of a smaller surface area as compared to the membrane electrolyte such that edges of the membrane electrolyte protrude outward from the electrodes. On these edges of the membrane electrolyte, gaskets or seals are disposed to peripherally frame the electrodes. Due to the limitations of manufacturing tolerances, however, the seals, MEA, and gas distribution elements are not adequately closely aligned. Due to the misalignment of these elements, failures at the edges of the membrane electrolyte can develop and shorten the life span of the fuel cell and decrease the performance of the fuel cell.

Moreover, tensile stresses on the membrane electrolyte that are caused by membrane shrinkage when the membrane electrolyte is cycled from wet to dry conditions, and chemical degradation of the membrane electrolyte due to chemical attack of the electrolyte in the membrane and the electrodes by free radicals produced by reaction of cross-over gases (hydrogen from the anode to the cathode, and oxygen from the cathode to the anode) also affect the life span and performance of a fuel cell. As such, it is desirable to develop a PEM fuel cell that eliminates the above drawbacks.

### SUMMARY

Accordingly, a method of forming a fuel cell may include treating a surface of a membrane electrode assembly (MEA) of the fuel cell, positioning a preformed adhesive insert on the treated surface, and bonding an electrically conductive member to the treated surface with the adhesive. Treating the surface may include a pre-treatment to increase adhesive properties thereof. Positioning the adhesive insert may include locating the adhesive insert on a surface of the membrane electrolyte adjacent to an edge of the electrode.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1A and 1B are exploded, cross-sectional views of a membrane electrode assembly (MEA) according to a principle and first embodiment of the present disclosure;

FIG. 2 is a cross-sectional view of a prior art membrane electrode assembly;

FIG. 3 is a cross-sectional view of the MEA shown in FIGS. 1A and 1B in an assembled form;

FIG. 4 is a cross-sectional view of the MEA shown in FIG. 3 depicting the prevention of a condensed flux of gases from crossing a membrane electrolyte; and

FIG. 5 is a cross-sectional view of MEA according to a principle and second embodiment of the present disclosure.

### DETAILED DESCRIPTION

The following description is merely exemplary in nature and is in no way intended to limit the disclosure, its application, or uses.

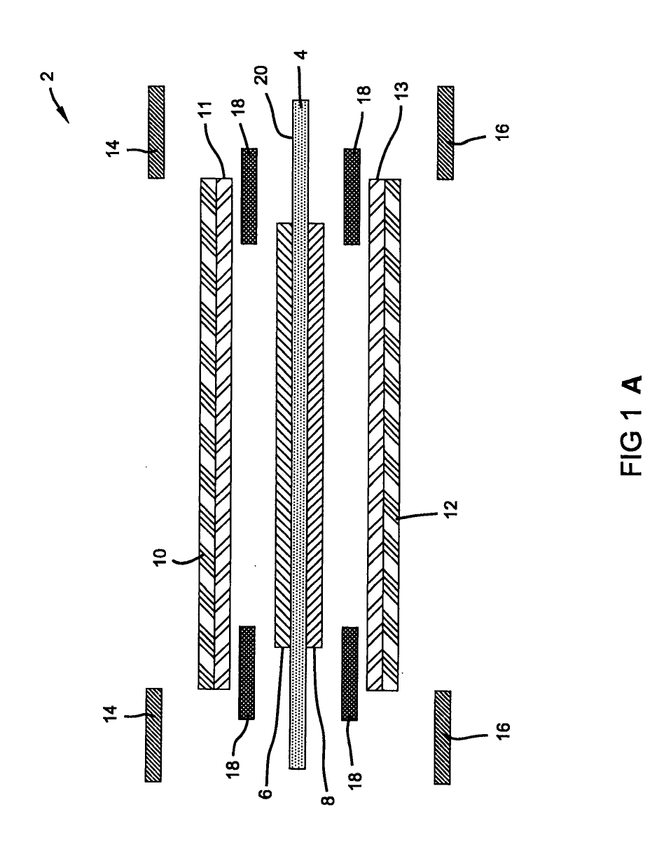

FIGS. 1A and 1B are exploded, cross-sectional views of a membrane electrode assembly (MEA) according to a principle of the present disclosure. As shown in FIGS. 1A and 1B, the MEA 2 includes an ionically conductive member 4 disposed between an anode electrode 6 and a cathode electrode 8. The MEA 2 is further disposed between a pair of electrically conductive members 10 and 12, or gas diffusion media 10 and 12. The gas diffusion media 10 and 12 are peripherally surrounded by frame-shaped gaskets 14 and 16. The gaskets 14 and 16 and diffusion media 10 and 12 may or may not be laminated to the ionically conductive member 4 and/or the electrodes 6 and 8.

The ionically conductive member 4 is a solid polymer membrane electrolyte, and more specifically a PEM. Member 4 is also referred to herein as a membrane 4. The ionically conductive member 4 has a thickness in the range of about 10 μm-100 micrometers, and more specifically a thickness of about 25 micrometers. Polymers suitable for such membrane electrolytes are well known in the art and are described in U.S. Pat. Nos. 5,272,017 and 3,134,697 and elsewhere in the patent and non-patent literature. It should be noted, however, that the composition of the ionically conductive member 4 may comprise any of the proton conductive polymers conventionally used in the art. For example, perfluorinated sulfonic acid polymers such as NAFION® are used. Furthermore, the polymer may be the sole constituent of the membrane, contain mechanically supporting fibrils of another material, or be interspersed with particles (e.g., with silica, zeolites, or other similar particles). Alternatively, the polymer or ionomer may be carried in the pores of another material.

In the fuel cell of the present disclosure, the ionically conductive member 4 is a cation permeable, proton conductive membrane, having H⁺ ions as the mobile ion; the fuel gas is hydrogen (or reformate) and the oxidant is oxygen or air. The overall cell reaction is the oxidation of hydrogen to water and the respective reactions at the anode and cathode are H₂=2H⁺+2e⁻ (anode) and ½ O₂+2H⁺+2e⁻=H₂O (cathode).

The composition of the anode electrode 6 and cathode electrode 8 comprises electrochemically active material dispersed in a polymer binder which, like the ionically conductive member 4, is a proton conductive material such as NAFION®. The electrochemically active material comprises catalyst-coated carbon or graphite particles. The anode electrode 6 and cathode electrode 8 may include platinum-ruthenium, platinum, or other Pt/transition-metal-alloys as the catalyst. Although the anode 6 and cathode 8 in the figures are shown to be equal in size, it should be noted that it is not out of the scope of the disclosure for the anode 6 and cathode 8 to be of different size (i.e., the cathode larger than the anode or vice versa). A thickness of the anode 6 and cathode 8 is in the range of about 2-30 μm, and more specifically about 10 μm.

The gas diffusion media 10 and 12 and gaskets 14 and 16 may be any gas diffusion media or gasket known in the art. For example, the gas diffusion media 10 and 12 are carbon papers, carbon cloths, or carbon foams with a thickness of in the range of about 50-300 μm. Further, the gas diffusion media 10 and 12 may be impregnated with various levels of Teflon® or other fluorocarbons to achieve more or less hydrophobicity. The gaskets 14 and 16 are typically elastomeric in nature but may also comprise materials such as polyester and PTFE. However, the gaskets 14 and 16 may be any material sufficient for sealing the membrane electrode assembly 2. A thickness of the gaskets 14 and 16 is approximately ½ the thickness of the gas diffusion media 10 and 12 to about 1½ times the thickness of the gas diffusion media 10 and 12.

In accordance with a first embodiment of the disclosure shown in FIGS. 1A and 1B, an adhesive 18 that is used to bond the diffusion media 10 and 12 to the MEA 2 is disposed at an edge 20 or peripheral surface 20 of the membrane electrolyte 4 to overlap the electrodes 6 and 8 and membrane electrolyte 4. The adhesive 18 is a hot-melt adhesive such as ethyl vinyl acetate (EVA), polyamide, polyolefin, or polyester. By disposing an adhesive 18 between the diffusion media 10 and 12 and membrane 4 (FIG. 1A), or between the electrodes 6 and 8 and membrane 4 (FIG. 1B), the durability of the membrane edge 20 is improved. It should be understood that the application of a hot melt adhesive 18 is merely exemplary and the present disclosure should not be limited thereto. More particularly, other adhesives 18 such as silicone, polyurethane, and fluoroelastomers may be used as the adhesive 18. Further, elastomer systems such as thermoplastic elastomers, epoxides, phenoxys, acrylics, and pressure sensitive adhesive systems may also be used as the adhesive 18. The application of the adhesive 18 at the peripheral surface 20 of the membrane electrolyte 4 reduces and homogenizes the tensile stresses located at the edge 20 of the membrane electrolyte 4 that is not supported by the electrodes 6 and 8, and prevents a chemical degradation of the membrane electrolyte 4.

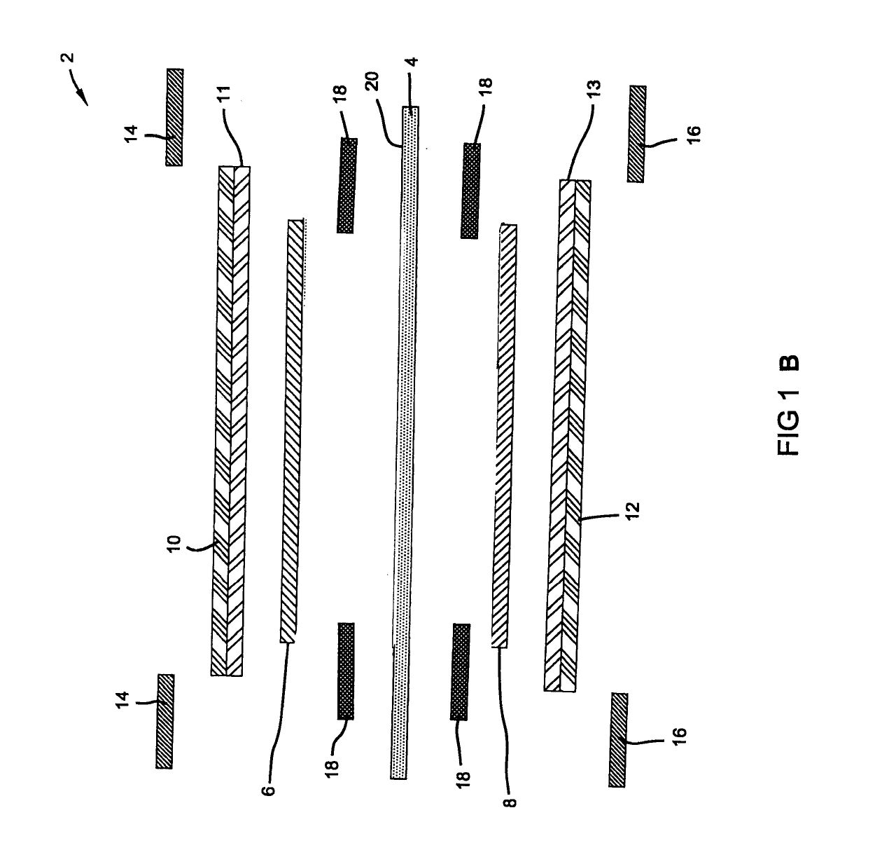

More particularly, referring to FIG. 2, a prior art MEA 22 is depicted. The prior art MEA 22 includes electrodes 24 and 26 with a much smaller surface area in comparison to the membrane electrolyte 28 such that edges 30 of the membrane electrolyte 28 protrude outward from the electrodes 24 and 26. On these edges 30 of the membrane electrolyte 28, rest sub-gaskets 32 and 34, that are disposed to surround the electrodes 24 and 26. Gas diffusion media 36 and 38 sit upon the sub-gaskets 32 and 34. Gaskets 40 and 42 surround the gas diffusion media 36 and 38.

Due to difficulty in manufacturing to tight tolerances, there is a gap 44 between the electrode 24 and 26 and sub-gaskets 32 and 34. Such a gap 44 acts as a living hinge, permitting the membrane 28 to flex. Such a hinge action leads to stress and tears, rips, or holes in the edges 30 of the membrane electrolyte 28. This also leads to stress as the compressive force acting on membrane electrolyte 28 differs due to such difference in height. For example, if the sub-gaskets 32 or 34 are higher than the electrode 24 or 26, the compressive forces on the sub-gaskets 32 and 34 will be too high, if the sub-gasket 32 or 34 is shorter than the electrode 24 or 26, the compressive forces on the electrode 24 or 26 will be too high. Thus, the arrangement typical in the prior art causes the small gap 44 formed between the sub-gaskets 32 and 34 and the electrodes 24 and 26. This small gap 44 leaves a small portion of the membrane electrolyte 28 unsupported.

Furthermore, if the sub-gaskets 32 and 34 are thicker than the electrodes 24 and 26, they form a “step” upon which gas diffusion media 36 and 38 rest. Gas diffusion media 36 and 38 assist in dispersing reactant gases H₂ and O₂ over the electrodes 24 and 26 and conduct current from the electrodes 24 and 26 to lands of the electrically conductive bipolar plates (not shown). As such, in order to facilitate electrical conductivity between the gas diffusion media 36 and 38 and electrodes 24 and 26, the membrane electrode assembly 22 needs to be compressed at a high pressure. This puts a great deal of stress on the unsupported portion of the membrane electrolyte 28 which may cause it to develop small pinholes or tears. The pinholes are also caused by the carbon or graphite fibers of the diffusion media 36 and 38 puncturing the membrane electrolyte 28. These fiber punctures cause the fuel cell to short and produce a lower cell potential.

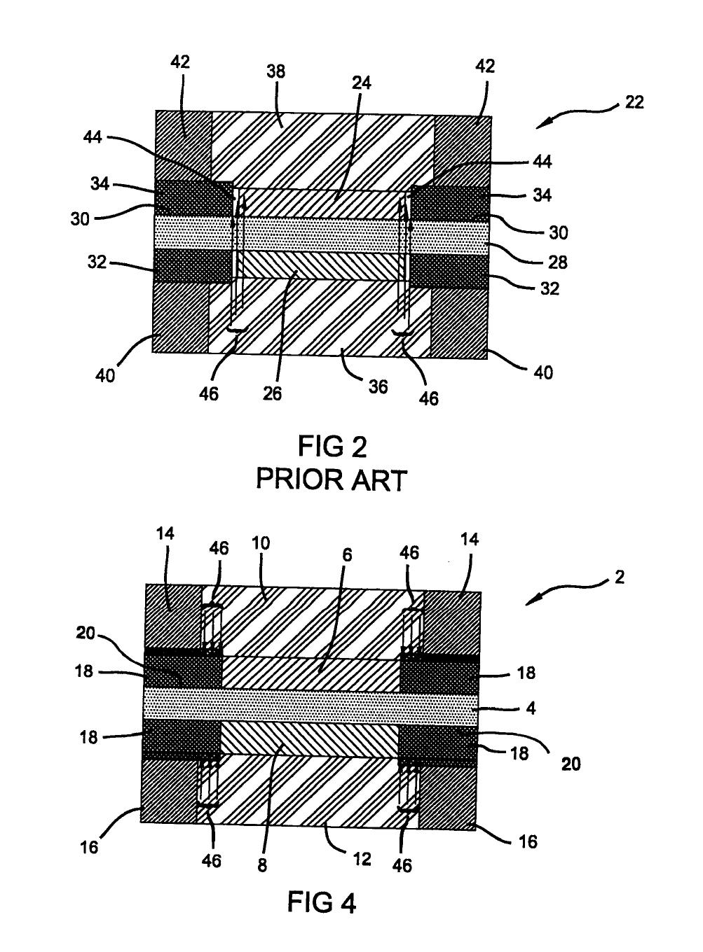

Now referring to FIG. 3, a cross-sectional view of the membrane electrode assembly 2 according to a principle of the present disclosure, in its assembled form, is depicted. In FIG. 3, it can be seen that each of the elements of the membrane electrode assembly 2 have been bonded together by the adhesive 18. Since the gas diffusion media 10 and 12 are a porous material, the adhesive 18 enters the pores of the gas diffusion media 10 and 12 when the elements of the fuel cell are compressed together. Upon solidification of the adhesive 18, the adhesive 18 acts as a seal around the peripheral surface 20 of the membrane electrolyte 4 that bonds the peripheral surface 20 of the membrane electrolyte 4, the electrodes 6 and 8, and the gas diffusion media 10 and 12 together. Since the membrane electrolyte 4, electrodes 6 and 8, and gas diffusion media 10 and 12 are bonded together, a unitary structure is formed. As such, no gaps are present between each of the elements of the fuel cell, and the membrane electrolyte 4 can be subjected to uniform pressures throughout its surface. The uniform pressures prevent the exertion of any tensile stresses on the membrane electrolyte 4, which prevents the occurrence of pinholes and degradation of the membrane electrolyte 4. A long-lasting and robust fuel cell with high performance is thus achieved.

Moreover, the adhesive 18 prevents the diffusion of hydrogen and oxygen across the membrane electrolyte 4 at the membrane electrolyte edge 20 because the adhesive 18 has a sealing property. Since the adhesive 18 has a sealing property that prevents the constituent reactants (i.e., H₂ and O₂) from diffusing across the membrane 4 at its edge 20, the chemical degradation of the membrane electrolyte 4 is prevented.

That is, during the normal operation of a fuel cell, hydrogen and oxygen gas may permeate across the membrane electrolyte 4 to both the cathode 8 and anode 6, respectively, such that oxygen is in the presence of the hydrogen. When these reactant gases comes into contact with the electrochemically active material of the electrodes 6 and 8, the oxygen is reduced and reacts with H⁺ ions produced from the oxidation of the hydrogen fuel gas. This ensuing side reaction between the reduced oxygen and H⁺ ions produces H₂O₂ as follows:
O₂+2H⁺+2e⁻=H₂O₂

This production of H₂O₂ has been known to cause a degradation of the membrane electrolyte 4 and, thus, a diminished fuel cell life and performance. Furthermore, it is generally understood that other possible mechanisms of chemical degradation of the electrolyte in the membrane and the electrodes can be mitigated in the absence of gas cross-over through the membrane 4. Again referring to the prior art membrane electrode assembly shown in FIG. 2, these gases are more prone to permeate the membrane 28 at the edges of the membrane 28 at the so-called gaps 44 between the elements of the fuel cell caused by manufacturing tolerances of the elements. As such, a condensed flux 46 of the reactant gases may collect at a region located where edges of the electrodes 24 and 26 meet the unsupported and unsealed membrane electrolyte 28 which can form H₂O₂ and chemically degrade the membrane electrolyte 28. That is, when the condensed flux 46 that collects in this gap 44 contacts the electrochemically active material of the electrodes 24 and 26, the production of H₂O₂ occurs.

Specifically, when contaminates or impurities are present in the fuel cell environment such as metal cations that have multiple oxidation states, the H₂O₂ in the presence of these metal cations may break down into a peroxide radical that may attack the ionomer of the membrane 28 and electrodes 24 and 26. Since a condensed flux 46 tends to form at the edges of the membrane 28, the edges of the membrane 28 are particularly susceptible to degradation.

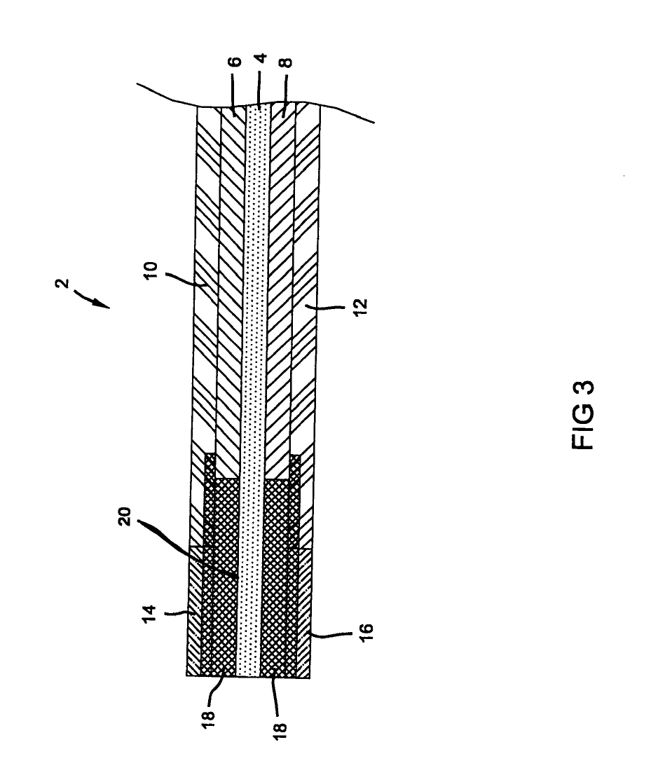

Now referring to FIG. 4, where the peripheral surface of the membrane electrolyte 20 is supported and sealed by the adhesive 18, the condensed flux of gases 46 that may collect at the peripheral surface 20 of the membrane is prevented from diffusing across the membrane electrolyte 4 by the adhesive 18. As such, the condensed flux of gases 46 are prevented from contacting the electrochemically active area of the electrodes 6 and 8, which prevents the production of H₂O₂. The degradation of the membrane electrolyte 4 at the edge 20 of the membrane electrolyte 4, therefore, is prevented.

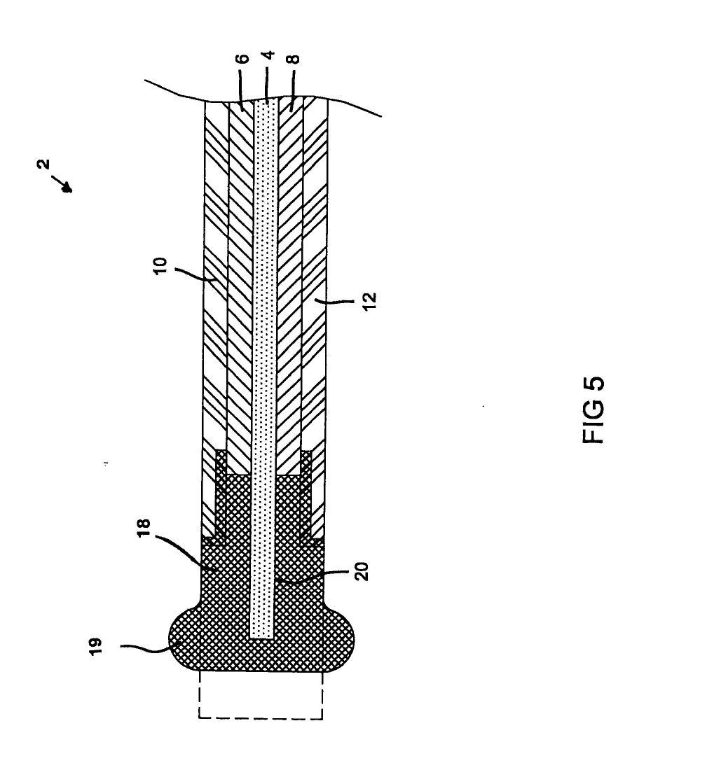

Now referring to FIG. 5, a second embodiment of the present disclosure will be described. As shown in FIG. 5, the adhesive 18 is applied to the edge of MEA 2 such that no gaskets are needed. That is, the adhesive 18 may be applied by way of injection molding or applied as a plug or insert that is heated and compression molded to seal the entire outer portion of the MEA 2. When the adhesive 18 is applied as a plug that is compression molded, the adhesive 18 takes the form as shown by the lines in phantom. In this manner, the elements of the MEA 2 are bonded together to form a unitary structure that provides uniform mechanical support throughout the entire structure of the MEA 2 when the MEA 2 is compressed in fuel cell.

A unique aspect of the second embodiment depicted in FIG. 5 are the projecting portions 19 formed on the edges of the adhesive 18. These bulbous portions 19 may serve as gaskets for the MEA 2 such that when the MEA 2 is compressed along with a plurality of the MEA's 2 in a fuel cell stack, further mechanical support is provided at the edges of the MEA 2 in the stack. This is because the adhesive 18, even after it solidifies after molding onto the MEA 2, will remain a bendable and pliable material.

It should be understood that the MEA 2 according to the second embodiment of the present disclosure also provides, in addition to the above-described mechanical support characteristics, the same sealing properties that prevent cross-over of the reactant gases across the membrane as described with reference to the first embodiment. That is, the adhesive 18 reduces or prevents the cross-over of hydrogen and oxygen across the membrane 4 such that the production of H₂O₂ can be prevented. Moreover, the adhesive 18 that is applied by injection molding or as a plug that is compression molded also may imbibe into the gas diffusion media 10 and 12.

A method of preparing the MEA 2 shown in FIGS. 1A and 1B according to the present disclosure will now be described. In order to prepare the anode 6 and cathode 8 of the MEA 2, catalyzed carbon particles are prepared and then combined with the ionomer binder in solution with a casting solvent. For example, the anode 6 and cathode 8 comprise ⅓ carbon or graphite, ⅓ ionomer, and ⅓ catalyst. Casting solvents may be aqueous or alcoholic in nature, but solvents such as dimethylacetic acid (DMAc) or trifluoroacetic acid (TFA) also may be used.

The casting solution is applied to a sheet suitable for use in a decal method, more specifically the sheet is a Teflonated sheet. The sheet is subsequently hot-pressed to the ionically conductive member 4 (membrane electrolyte), such as a PEM, to form a catalyst coated membrane (CCM). The sheet is then peeled from the ionically conductive member 4 and the catalyst coated carbon or graphite remains embedded as a continuous electrode 6 or 8 to form the MEA 2. Alternatively, the casting solution may be applied directly to the gas diffusion medium 10 or 12 to form a catalyst coated diffusion medium (CCDM).

It should also be understood that it may be desirable to have a microporous layer 11 and 13 formed on the gas diffusion media 10 or 12. The microporous layer 11 and 13, which is a water management layer that wicks water away from the membrane 4, may be formed in the same manner as the electrodes 6 and 8, described above, but the casting solution is comprised of carbon particles and a Teflon® solution.

To apply the adhesive 18, a variety of methods may be employed. That is, the adhesive 18 may be applied as a film, as a slug, or sprayed onto the edge 20 of the membrane electrolyte 4, the electrodes 6 and 8, and gas diffusion media 10 and 12. Further, as described above with reference to the second embodiment, the adhesive may be injection molded onto the edge of the MEA 2. After the adhesive 18 has been applied, the elements of the MEA 2 are bonded to form a unitary structure by heating the adhesive to a melting point dependent on the type of material being used as the adhesive and applying pressure in the range of 10-20 psi. The bonding temperature of the adhesive may be in the range of 270 F-380 F. Utilizing temperatures in this range prevents subjecting the delicate materials of the MEA 2 such as the membrane electrolyte 4 and electrodes 6 and 8 to temperatures that may cause a degradation of these materials.

In a unique aspect of the disclosure, before applying the adhesive 18, the membrane electrolyte 4, electrodes 6 and 8, and gas diffusion media 10 and 12 are subjected to a pre-treatment. That is, the membrane electrolyte 4, electrodes 6 and 8, and gas diffusion media 10 and 12 are pre-treated with a surface treatment that activates the surfaces of these materials. For example, a radio-frequency glow discharge treatment is used. Additional pre-treatments that also activate the surfaces of these materials are a sodium napthalate etching treatment, a corona discharge treatment, a flame treatment, a plasma treatment, a UV treatment, a wet chemical treatment, a surface diffusion treatment, a sputter etching treatment, an ion beam etching treatment, an RF sputter etching treatment, and the use of a primer.

With respect to plasma treatments, a variety of plasma-based techniques can be used such as plasma-based flame treatment, a plasma-based UV or UV/ozone treatment, an atmospheric pressure discharge plasma treatment, and a low pressure plasma treatment. These plasma treatments clean, chemically activate, and coat the elements of the MEA 2. Other plasma treatments that may be used are a dielectric barrier discharge plasma treatment, a sputter deposition plasma treatment (DC and RF magnetically enhanced plasma), an etching plasma treatment (RF and microwave plasmas, and RF and microwave magnetically enhanced plasmas), a sputter etching plasma treatment, an RF sputter etching plasma treatment, an ion beam etching plasma treatment, a glow discharge plasma treatment, and a capacitive coupled plasma treatment.

The use of a pre-treatment increases the adhesive force between the elements of the MEA 2 by exciting or activating the polymeric groups of the membrane electrolyte 4, the electrodes 6 and 8, and the gas diffusion media 10 and 12. This is advantageous because polymers and plastics are low surface energy materials and most high strength adhesives do not spontaneously wet their surfaces. This is also advantageous because a surface pre-treatment provides a reproducible surface so that the adhesive effects of the adhesive 18 can be consistent from product to product. As such, by activating the surfaces of the membrane electrolyte 4, electrodes 6 and 8, and gas diffusion media 10 and 12, the adhesive force of the adhesive 18 is increased which results in an increased sealing effect of the MEA 2. Further, the increased adhesive force between the elements of the MEA 2 provides a more robust MEA 2 that increases resistance to mechanical and chemical stresses.

That is, by using a pre-treatment, the surface energy of the elements will rise such that radicals will form at the ends of the polymeric groups that form the membrane electrolyte 4, the electrodes 6 and 8, and the diffusion media 10 and 12. These radicals attract the molecules of the adhesive 18 when the adhesive 18 is applied to thereby “bond” the elements of the MEA 2 with the adhesive 18. Further, it should be understood that the above surface treatments increases the surface energy of the elements of the MEA 2 by inducing chemical changes and physical changes in the polymeric elements of the MEA 2.

More specifically, the elements of the MEA 2 may be chemically altered by the above pre-treatments by the incorporation of a new chemical species, the loss of a chemical species, radical formation, and interaction of the treated surfaces of the elements of the MEA 2 with the atmosphere in which the pre-treatment is conducted. Physical changes that can occur in the elements of the MEA 2 include chain scission, the creation of low molecular weight fragments, surface cross-linking, the reorientation of surface groups, and the etching and removal of surface species. It should be noted, however, that the physical changes usually change the surface chemistry of the elements of the MEA 2 in addition to providing the physical changes.

Moreover, if the pretreatment of the elements of the MEA 2 is performed in an atmosphere consisting of air with a reactive gas containing a suitable chemical species such as argon, nitrogen, silane, or any other gas that can produce radicals that is bled in, the adhesion characteristics between the elements can be further augmented. That is, when the radicals form at the ends of the polymeric groups that form the membrane 4, the electrodes 6 and 8, and the diffusion media 10 and 12, the chemical species bled into the atmosphere also form radicals that can bond to the radicals formed at the ends of the polymeric groups. When the elements of the MEA 2 are then compressed together to facilitate contact between the elements of the MEA 2, the chemical species may then bond together to tightly connect the elements of the MEA 2. For example, if a nitrogen containing reactive gas is bled into the atmosphere during the pretreatment, nitrogen radicals will form at the ends of the polymeric groups of the elements of the MEA 2. When the elements are compressed together, the nitrogen radicals of one element will bond with the nitrogen radicals of another element to form nitrogen bonds, which are very strong.

In the case of a corona treatment, it is desirable that the treatment be conducted in an atmosphere containing air with a nitrogen or argon gas bled in. With respect to a radio frequency glow discharge treatment, it is desirable that the treatment be conducted in a vacuum with a reactive gas such as argon or nitrogen bled in. Alternatively, a carbonaceous or salacious gas may be bled in, or other gases such as oxygen or He—O blends may be used.

It should also be understood that, after performing a pretreatment and before compressing the elements of the MEA 2 together, a primer or coupling agent may be applied to the elements of the MEA 2. In this regard, the primer or coupling agent may be any primer or coupling agent known in the art, but should be selected specifically to the application used as the pretreatment.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A method comprising:
treating a surface of a membrane electrode assembly (MEA) of a fuel cell with a pre-treatment to increase adhesive properties thereof;
applying an adhesive to the treated surface; and
bonding an electrically conductive member to the treated surface with the adhesive.

2. The method of claim 1, wherein said treating includes applying a radio-frequency glow charge treatment to the MEA surface.

3. The method of claim 1, wherein said treating includes applying a sodium napthalate treatment to the MEA surface.

4. The method of claim 1, wherein said treating includes applying a corona discharge treatment to the MEA surface.

5. The method of claim 1, wherein said treating includes applying a flame treatment to the MEA surface.

6. The method of claim 1, wherein the adhesive includes at least one hot-melt adhesive selected from the group consisting of ethylene vinyl acetate (EVA), polyamide, polyolefin, polyester, and mixtures thereof.

7. The method according to claim 1, further comprising applying one of a a primer and a coupling agent to the MEA surface after said treating and before said applying the adhesive.

8. A method comprising:
positioning a preformed adhesive insert relative to a membrane electrode assembly (MEA) of a fuel cell including a membrane electrolyte and an electrode, said positioning including locating the adhesive insert on a surface of the membrane electrolyte adjacent to an edge of the electrode; and
bonding an electrically conductive member to the MEA with the adhesive.

9. The method of claim 8, wherein said bonding includes heating and compression molding the adhesive insert to seal an outer periphery of the MEA.

10. The method of claim 8, wherein said bonding includes the adhesive insert permeating the electrically conductive member.

11. The method of claim 8, wherein said bonding includes the adhesive abutting the edge of the electrode.

12. The method of claim 8, wherein the adhesive includes at least one hot-melt adhesive selected from the group consisting of ethylene vinyl acetate (EVA), polyamide, polyolefin, polyester, and mixtures thereof.

13. A method comprising:
treating a surface of a membrane electrode assembly (MEA) of a fuel cell with a pre-treatment to increase adhesive properties thereof;
positioning a preformed adhesive insert on the treated surface, said positioning including locating the adhesive insert on a surface of a membrane electrolyte of the MEA adjacent to an edge of an electrode of the MEA; and
bonding an electrically conductive member to the treated surface with the adhesive.

14. The method of claim 13, wherein said treating includes applying a radio-frequency glow charge treatment to the MEA surface.

15. The method of claim 13, wherein said treating includes applying a sodium napthalate treatment to the MEA surface.

16. The method of claim 13, wherein said treating includes applying a corona discharge treatment to the MEA surface.

17. The method of claim 13, wherein said treating includes applying a flame treatment to the MEA surface.

18. The method of claim 13, wherein said bonding includes heating and compression molding the adhesive insert to seal an outer periphery of the MEA.

19. The method of claim 13, wherein said bonding includes the adhesive insert permeating the electrically conductive member.

20. The method of claim 13, wherein the adhesive includes at least one hot-melt adhesive selected from the group consisting of ethylene vinyl acetate (EVA), polyamide, polyolefin, polyester, and mixtures thereof.
